(19) United States
(12) Patent Application Publication
(10) Pub. No.: US 2026/0237698 A1
(43) Pub. Date: Aug. 13, 2026

(54) DRYING METHOD FOR DRYING A FUEL CELL STACK

(71) Applicant: Robert Bosch GmbH, Stuttgart (DE)

(72) Inventors: Fabian Straub, Stuttgart (DE); Helerson Kemmer, Vaihingen (DE); Matthias Rink, Herrenberg (DE); Rajendra Prasad Bandi, Taverekere (IN)

(21) Appl. No.: 19/156,486

(22) PCT Filed: Feb. 7, 2024
(86) PCT No.: PCT/EP2024/053061

§ 371 Date: Aug. 14, 2025

(30) Foreign Application Priority Data
Feb. 14, 2023 (DE) 10 2023 201 242.1

(51) Int. Cl. H01M 8/0432; H01M 8/04029; H01M 8/04119; H01M 8/04223; H01M 8/04228

(52) U.S. Cl. CPC H01M 8/04358; H01M 8/04029; H01M 8/04179; H01M 8/04228; H01M 8/04231

(57) ABSTRACT

The present invention relates to a drying method (100) for drying a fuel cell system (201).

The drying method (200) comprises:
a first drying phase (103), in which a coolant temperature of coolant flowing through the fuel cell stack (201) is adjusted to a first coolant temperature target value and is maintained, and
a second drying phase (111), in which the coolant temperature is adjusted to a second coolant temperature target value,
   the first coolant temperature target value being higher than the second coolant temperature target value.

### BACKGROUND

The invention presented here relates to a drying method for drying a fuel cell system and a fuel cell system according.

In fuel cell systems, the oxidizing agent oxygen from the ambient air and hydrogen as a reducing agent and fuel are generally used to react in the fuel cell to form water or water vapor and thus deliver electrical power through electrochemical conversion.

A major technical challenge for mobile fuel cell systems is to functionally realize a start under all globally relevant conditions and with different downtimes while still achieving the respective specified service life requirements.

When starting under freezing conditions, i.e. starting at low outside temperatures of, for example, below 4° C., it is necessary to heat a fuel cell stack as quickly as possible over a critical temperature of 0° C. so that product water produced during operation of the fuel cell stack does not freeze, particularly at critical locations in the fuel cell stack, such as thin conduits or bends.

In the event of a faulty start under freezing conditions, both the fuel cell stack may suffer massively irreversible damage and the fuel cell system may not be able to start, so that the fuel cell system must be brought into a “warm” environment.

For a successful start under freezing conditions, it is relevant how much water the fuel cell stack contains before the start under freezing conditions or at the beginning of the start under freezing conditions. This amount of water must be within a tolerance range so that the fuel cell stack can still store product water that accumulates during the start under freezing conditions in its storable components, such as a membrane, a gas diffusion layer, etc., without becoming blocked by freezing water, and so that no proton conductivity of the membrane is possible or the membrane is damaged by excessively dry conditions.

### SUMMARY

Presented in the context of the invention are a drying method for drying a fuel cell system and a fuel cell system. Further features and details of the invention arise from the respective dependent claims, the description, and the drawings. In this context, features and details described in connection with the drying method according to the invention clearly also apply in connection with the fuel cell system according to the invention, and respectively vice versa, so that mutual reference to the individual considerations of the invention always is or can be made with respect to the disclosure.

The present invention serves in particular to enable a reliable start under freezing conditions of a fuel cell system.

Therefore, according to a first aspect of the invention presented, a drying method for drying a fuel cell system is presented. The drying method comprises a first drying phase in which a coolant temperature of coolant flowing through the fuel cell stack is adjusted to a first coolant temperature target value and is maintained, and a second drying phase in which the coolant temperature is adjusted to a second coolant temperature target value, the first coolant temperature target value being greater than the second coolant temperature target value.

The presented drying process is based on a multi-stage drying process in which different temperatures are adjusted in the fuel cell stack during different drying phases. This ensures that the fuel cell stack is not too moist when turned off.

Furthermore, the drying process presented prevents the fuel cell stack from being turned off when too warm, especially at low ambient temperatures, so that water subsequently evaporates, re-distributed and condensed at unfavorable positions in the fuel cell system during a cooling operation. Correspondingly, the presented drying method excludes problems for a start under freezing conditions, such as icing, a degradation, damage or malfunction of the fuel cell stack.

To adjust different temperatures in the fuel cell stack, a coolant temperature of coolant flowing through the fuel cell stack is adjusted, i.e., altered. For example, a coolant flow directed to a radiator may be adjusted to adjust the coolant temperature.

In the first drying phase of the presented drying process, the coolant temperature is adjusted at a high temperature level of, for example, 60° C. Due to a high temperature level, air passing through the fuel cell stack can absorb a lot of water until the air is filled with water or water vapor. Thus, efficient and fast drying of the fuel cell stack may be performed.

Following the first drying phase, the coolant temperature for the second drying phase is adjusted or controlled to a lower temperature level, thereby achieving cooling and homogenization of a temperature of the fuel cell stack. This means that the temperature ideally prevails throughout the entire fuel cell stack and critical areas where moisture can accumulate are avoided.

Another effect of the second drying phase is the removal of additionally condensed water. For example, the cathode tract can be blown out and hydrogen can flow through the anode tract and the purge or drain valve can be opened both in the first drying phase and the second drying phase.

It may be provided that the first drying phase is performed or carried out for a predetermined period of time until an anode moisture in an anode tract of the fuel cell stack and a cathode moisture in a cathode tract of the fuel cell stack is below a predetermined moisture threshold value, or is performed until a difference of a fluid temperature of fluid flowing through the fuel cell stack compared with the coolant temperature is above a predetermined first temperature difference threshold value.

The end of the first drying phase on the anode side and on the cathode side can be timed or predetermined or determined on the basis of temperature differences between the fuel cell stack or the anode tract and the cathode tract and the coolant or the progression of outlet temperatures of fluid flows flowing out of the anode tract or the cathode tract.

To adjust or set or adjust the coolant temperature after the end of the first drying phase to the second coolant temperature target value, a 3-way valve of a cooling system of the fuel cell system may be adjusted such that the entire cooling mass flow is run across a radiator of the cooling system so that a rapid lowering of the coolant temperature is achieved. For example, a radiator outlet temperature can be controlled down to an allowable minimum temperature even during the first drying phase with the help of a radiator fan.

The start of the second drying phase is carried out, for example, if the target value of the coolant temperature, for example, has reached a target value of a ramp function and/or a coolant input temperature, measured at a coolant entry of the fuel cell stack, corresponds to a second coolant temperature target value or is within an amount of the second coolant temperature target value and an admissible variance or a so-called “offset”.

It may further be provided that the second drying phase is performed for a predetermined period of time or is performed until a difference of a coolant inlet temperature measured at a coolant inlet of the fuel cell stack and a coolant outlet temperature measured at a coolant outlet of the fuel cell stack is below a predetermined second temperature.

The end of the second drying phase can be timed or predetermined or determined on the basis of temperature differences between the fuel cell stack or the anode tract and the cathode tract and the coolant or the progression of outlet temperatures of fluid flows flowing out of the anode tract or the cathode tract.

It may further be provided that the drying method further comprises flowing an anode fluid flow through an anode tract of the fuel cell stack by controlling a purge valve of the fuel cell stack at a predetermined flow rate, and flowing a cathode tract of the fuel cell stack at a predetermined flow mass flow rate provided by a blower for supplying fluid to the cathode tract, wherein during a transition of the coolant temperature from the first coolant temperature target value to the second coolant temperature target value, the flow rate at which the purge valve is controlled and the flow mass flow rate are reduced, and wherein the flow rate and the flow mass flow rate are increased again when the coolant temperature corresponds to the second coolant temperature target value.

By reducing the flow rate and flow rate of mass between the first drying phase and the second drying phase, a drying pause is introduced between the first drying phase and the second drying phase to avoid over-drying of the fuel cell stack.

It may further be provided that the coolant temperature of the coolant flowing through the fuel cell stack may be adjusted by means 3-way valve, wherein a greater coolant flow is directed through a radiator of the fuel cell system to reduce the coolant temperature.

By means of a 3-way valve, a coolant flow directed through a radiator and, as a result, a discharge of thermal energy from the coolant by the radiator can be quickly and accurately adjusted. To this end, the 3-way valve can, for example, switch between a cooling path through the radiator and a bypass path around or past the radiator, in particular gradually or continuously.

It may further be provided that the first coolant temperature target value is successively reduced to the second coolant temperature threshold value by way of a ramp function.

The coolant temperature can be reduced along a target value ramp in preparation for the second drying phase. The start of the second drying phase can occur, for example, when a target value along a ramp has reached its target value.

It may further be provided that the second coolant temperature threshold value is formed by a maximum of an application parameter, an ambient temperature of the fuel cell system, and a predetermined variance value.

If the end of the first drying phase is initiated, i.e., for example, the first coolant temperature target value is detected in the anode tract and cathode tract, the coolant temperature is adjusted to the second, lower coolant temperature target value. The second coolant temperature target value can be formed from the maximum selection between an application parameter and the sum of an ambient temperature and a variance value or a so-called “offset”.

The sum of the ambient temperature and the variance value is a minimum viable coolant temperature in conventional cooling systems.

It may further be provided that the drying method is started in response to a command to shut down the fuel cell system.

In order to enable a safe start under freezing conditions, the aforementioned drying process can be started when a respective fuel cell system or vehicle is turned off or deactivated.

According to a second aspect, the invention presented here relates to a fuel cell system for converting energy.

The fuel cell system presented comprises a fuel cell stack comprising an anode tract and a cathode tract, a purge valve for draining fluid from the anode tract, a metering valve for metering fluid into the anode tract, a blower for feeding a flow rate into the cathode tract, a cooling system, and a calculating unit, wherein the computation unit is configured to carry out a possible design of the drying method presented.

It may be provided that the cooling system includes a 3-way valve, a coolant pump supplying coolant to the fuel cell stack, and a heat exchanger in contact with an environment, wherein the 3-way valve is connected to a conduit to an outlet of the heat exchanger, a conduit to the coolant pump and a bypass conduit, and wherein the bypass conduit runs past the pump and the fuel cell stack and is connected to an input of the heat exchanger.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

Shown are:

FIG. 1 one possible embodiment of the present drying method,

FIG. 2 one possible embodiment of the presented fuel cell system.

### DETAILED DESCRIPTION

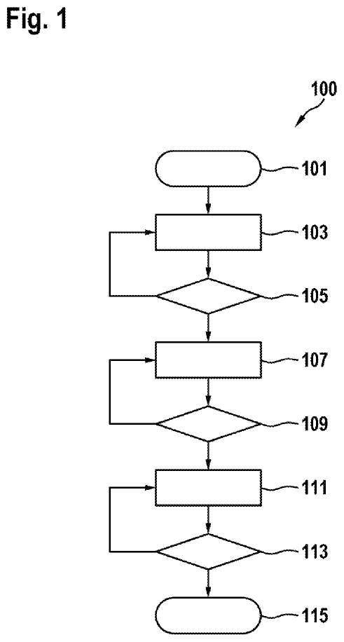

In FIG. 1, a drying method 100 is shown. The drying method 100 starts in response to a command to deactivate a fuel cell system in a start step 101.

In a first drying phase 103, a radiator outlet temperature is lowered to a minimum value, constant conditions are created in the anode tract of the fuel cell system by regularly adjusting for purge and draining processes, and a constant cathode mass air flow with a constant pressure level is adjusted in the cathode tract.

In a checking step 105, it is checked whether a predetermined drying duration is reached and/or a temperature-based criterion, such as reaching the first coolant temperature target value, such that if this is not applicable, the first drying phase 103 is continued or if this is true, a drying pause 107 is introduced.

In the drying pause 107, the cathode mass flow is decreased, a purge frequency and/or a purge duration is reduced, and the coolant temperature of the fuel cell stack is adjusted to the second coolant temperature target value.

In a checking step 109, it is checked whether a target value of a ramp function for adjusting the coolant temperature is reached and/or a measured coolant temperature of the fuel cell stack corresponds to the second coolant temperature target value, so that if this is not applicable, the drying pause 107 is continued or if this is true, a second drying phase 111 is started.

In the second drying phase 111, the anode tract is again regularly or increasingly flowed through with hydrogen and the cathode tract is increasingly flowed through with air.

In a checking step 113, it is checked whether a predetermined drying duration is reached and/or a coolant temperature, measured at the outlet or coolant outlet of the fuel cell stack, corresponds to a coolant temperature, measured at the inlet or coolant inlet of the fuel cell stack, possibly plus a predetermined variance value or so-called “offset”, so that, if this is not the case, the second drying phase 111 is continued or, if this is the case, a termination step 115 is initiated.

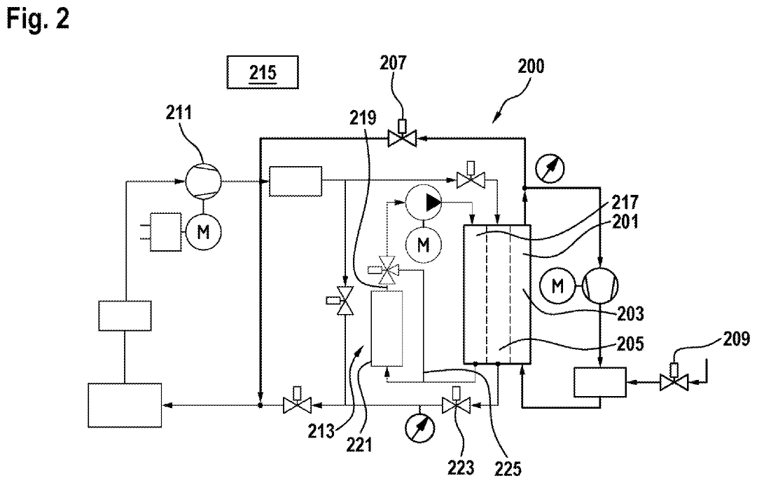

FIG. 2 shows a fuel cell system 200. The fuel cell system 200 comprises a fuel cell stack 201 comprising an anode tract 203 and a cathode tract 205, a purge valve 207 for draining fluid from the anode tract 203, a metering valve 209 for metering fluid into the anode tract 203, a blower 211 for feeding a flow rate into the cathode tract 205, a cooling system 213, and a computing unit 215.

The computing unit 215 is configured to perform the drying process 100 according to FIG. 1. To this end, the computing unit 215 is communicatively connected to a 3-way valve 223 of the cooling system 213 in order to divide a coolant flow flowing through a coolant path 217 of the fuel cell stack 201 between a cooling line 219 through a radiator 221 of the cooling system and a bypass line 225 past the radiator 221, and, as a result, to adjust a coolant temperature of the coolant or a fuel cell stack temperature of the fuel cell stack 201.

1. A drying method (100) for drying a fuel cell system (201),
wherein the drying method (200) comprises:
a first drying phase (103), in which a coolant temperature of coolant flowing through the fuel cell stack (201) is adjusted to a first coolant temperature target value and is maintained, and
a second drying phase (111), in which the coolant temperature is adjusted to a second coolant temperature target value,
wherein the first coolant temperature target value is higher than the second coolant temperature target value.

2. The drying method (100) according to claim 1,
wherein
the first drying phase (103) is performed for a predetermined period of time, or until an anode moisture in an anode tract (203) of the fuel cell stack (201) and a cathode moisture in a cathode tract (205) of the fuel cell stack (201) is below a predetermined moisture threshold value, or
until a difference of a fluid temperature of fluid flowing through the fuel cell stack (201) and the coolant temperature is above a predetermined first temperature difference threshold value.

3. The drying method (100) according to claim 1,
wherein
the second drying phase (111) is performed for a predetermined period of time, or until a difference of a coolant inlet temperature measured at a coolant inlet of the fuel cell stack (201), and a coolant outlet temperature measured at a coolant outlet of the fuel cell stack (201) is below a predetermined second temperature difference threshold value.

4. The drying method (100) according to claim 1,
wherein
the drying method (100) furthermore comprises:
flow of an anode fluid stream through an anode tract (203) of the fuel cell stack (201) by controlling a purge valve (207) of the fuel cell stack (201) at a predetermined flow rate,
flow of a predetermined flow mass flow provided by a blower (211) for supplying fluid to the cathode tract (205) through a cathode tract (205) of the fuel cell stack (201),
wherein during a transition of the coolant temperature from the first coolant temperature target value to the second coolant temperature target value, the flow rate at which the purge valve (207) is controlled and the flow rate of the flow mass flow rate is reduced, and
wherein the flow rate and flow mass flow rate are increased again when the coolant temperature corresponds to the second coolant temperature target value.

5. The drying method (100) according to claim 1,
wherein
the coolant temperature of the coolant flowing through the fuel cell stack (201) is adjusted by means of a 3-way valve (223),
wherein a larger coolant flow is directed through a radiator (221) of the fuel cell system (200) to reduce the coolant temperature.

6. The drying method (100) according to claim 1,
wherein
the first coolant temperature target value is successively reduced to the second coolant temperature threshold value by way of a ramp function.

7. The drying method (100) according to claim 1,
wherein
the second coolant temperature threshold value is formed by a maximum of an application parameter, an ambient temperature of the fuel cell system, and a predetermined variance value.

8. The drying method (100) according to claim 1,
wherein
the drying method is started in response to a command to shut down the fuel cell system.

9. A fuel cell system (200) for converting energy,
wherein the fuel cell system (200) comprises the following:
a fuel cell stack (201) comprising an anode tract (201) and a cathode tract (203),
a purge valve (207) for draining fluid from the anode tract (203),
a metering valve (209) for metering fluid into the anode tract (203),
a blower (211) for feeding a flow rate into the cathode tract (205),
a cooling system (213),
a computer (215),
wherein the computer (215) is configured to carry out a drying method (100) according to claim 1.

10. The fuel cell system (200) according to claim 9,
wherein
the cooling system (213) comprises a 3-way valve (223), a coolant pump supplying coolant to the fuel cell stack (201), and a heat exchanger in contact with an environment,
wherein the 3-way valve (223) is connected to a conduit (219) to an outlet of the heat exchanger, a conduit to the coolant pump and a bypass conduit (225),
wherein the bypass conduit (225) passes the coolant pump and the fuel cell stack (201) and is connected to an input of the heat exchanger.
